(19) United States
(12) Patent Application Publication
(10) Pub. No.: US 2006/0169385 A1
(43) Pub. Date: Aug. 3, 2006

(54) System and method for dispensing labels based on manufacturing build options

(75) Inventors: Parit K. Sharma, Cambridge (CA); Matt Ferraro, Woodstock (CA); Michael Denomme, London (CA)

Correspondence Address: DOCKET CLERK, DM/EDS, P.O. DRAWER 800889, DALLAS, TX, 75380, US

(73) Assignee: Electronic Data Systems Corp., Plano, TX (US)

(21) Appl. No.: 11/048,519

(22) Filed: Feb. 1, 2005

(51) Int. Cl. B65C 9/40; B32B 38/00

(52) U.S. Cl. 156/64; 156/351; 156/362; 156/363; 156/378; 156/DIG. 44; 156/DIG. 45; 156/DIG. 1

(57) ABSTRACT

A label dispensing system and method for use in product assembly, with some embodiments particularly drawn to automotive and other assembly-line based environments. According to various embodiments, product labels are automatically and selectively dispensed at one or more assembly stations, as required by product specifications, to help ensure that all labels are properly affixed.

### TECHNICAL FIELD OF THE INVENTION

The present invention is directed, in general, to manufacturing processes and tools.

### BACKGROUND OF THE INVENTION

During the assembly process of a vehicle or other consumer goods, a number of pre-printed standard labels are attached to different locations on the product. These labels are all the same and come pre-printed from suppliers.

The operators on the floor are required to attach these labels to the different locations on the product, based on the type of product that is being built.

For example, for a vehicle being built on an assembly line, a child lock label is often attached to the inside of the rear side doors on four-door models. These labels instruct the users of the function of the locks that allow for the prevention of the doors opening from the inside of the vehicle.

The operators, who are responsible for attaching these labels, also have a number of other tasks they are responsible for during the assembly of the vehicle at the station.

Occasionally, the operator forgets to attach the label to a vehicle, and has no idea that this step has been missed. The vehicle leaves the plant and gets out to the distribution area, where it may undergo a quality-control inspection, or be directly sent out for sale.

During a quality-control inspection, vehicles with missing labels may be flagged with a major quality failure, which would directly impact the quality rating of all vehicles leaving the assembly plant.

Multiple types of label dispensing devices exist, with the majority of them dispensing Labels based on a signal from a photo-eye. When a label is pulled off from the dispenser, the dispenser feeds the next label automatically until the signal from the label breaks the beam of the photo-eye. No external signal source or system controls the feeding of the labels; they are simply dispensed when a label is pulled off.

There is, therefore, a need in the art for a system and method for dispensing labels based on manufacturing build options.

### SUMMARY OF THE INVENTION

A preferred embodiment provides a label dispensing system and method for use in product assembly, with some embodiments particularly drawn to automotive and other assembly-line based environments. According to various embodiments, product labels are automatically and selectively dispensed at one or more assembly stations, as required by product specifications, to help ensure that all labels are properly affixed.

The foregoing has outlined rather broadly the features and technical advantages of the present invention so that those skilled in the art may better understand the detailed description of the invention that follows. Additional features and advantages of the invention will be described hereinafter that form the subject of the claims of the invention. Those skilled in the art will appreciate that they may readily use the conception and the specific embodiment disclosed as a basis for modifying or designing other structures for carrying out the same purposes of the present invention. Those skilled in the art will also realize that such equivalent constructions do not depart from the spirit and scope of the invention in its broadest form.

Before undertaking the DETAILED DESCRIPTION OF THE INVENTION below, it may be advantageous to set forth definitions of certain words or phrases used throughout this patent document: the terms “include” and “comprise,” as well as derivatives thereof, mean inclusion without limitation; the term “or” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, whether such a device is implemented in hardware, firmware, software or some combination of at least two of the same. It should be noted that the functionality associated with any particular controller may be centralized or distributed, whether locally or remotely. Definitions for certain words and phrases are provided throughout this patent document, and those of ordinary skill in the art will understand that such definitions apply in many, if not most, instances to prior as well as future uses of such defined words and phrases.

### BRIEF DESCRIPTION OF THE DRAWINGS

For a more complete understanding of the present invention, and the advantages thereof, reference is now made to the following descriptions taken in conjunction with the accompanying drawings, wherein like numbers designate like objects, and in which:

FIG. 1 depicts a system context block diagram illustrating the interface between a label dispenser, PLC and upper-end system, in accordance with a preferred embodiment; and

FIG. 2 depicts a flowchart of a process in accordance with a preferred embodiment.

### DETAILED DESCRIPTION OF THE INVENTION

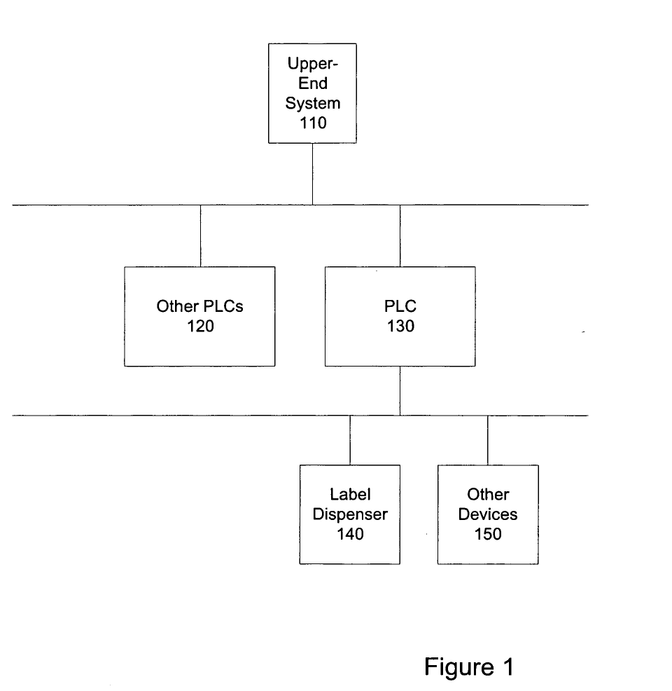

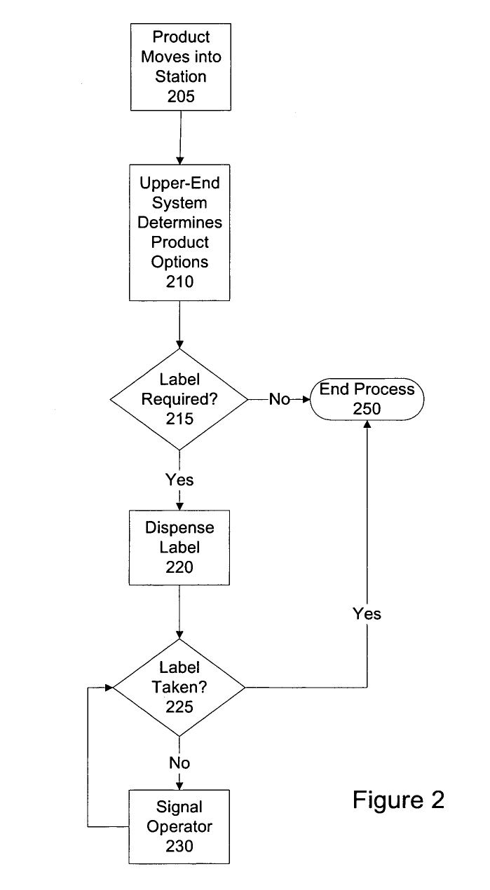

FIGS. 1 and 2, discussed below, and the various embodiments used to describe the principles of the present invention in this patent document are by way of illustration only and should not be construed in any way to limit the scope of the invention. Those skilled in the art will understand that the principles of the present invention may be implemented in any suitably arranged device. The numerous innovative teachings of the present application will be described with particular reference to the presently preferred embodiment.

While a preferred embodiment is described herein in the context of an automotive assembly plant, those of skill in the art will recognize that the claimed invention and other teachings below can be applied to other systems as well, wherever specific labels must be applied to a product or packaging.

Vehicles in an assembly shop are typically tracked through an upper-end system, such as the GE FANUC CIMPLICITY TRACKER. The upper-end system determines the different options for all vehicles. For example, the upper-end system knows when a vehicle enters and leaves a specific station, as well as the different options on the vehicle (2-door/4-door, transmission, etc.). The communication to the plant floor devices are performed through programmable logic controllers (PLCs) that trigger information to and from the upper-end system.

FIG. 1 depicts a block diagram of a system in accordance with a preferred embodiment. This embodiment includes a label dispenser 140, controlled through the upper-end system 110 and a PLC 130 that automatically dispenses a label for those vehicles for which a label is required, at each appropriate station. Of course, upper-end system 110 can also control other PLCs 120, and the PLC 130 can control other devices 150.

This embodiment includes a label dispenser 140 with an external signal cord. The external signal cord is then connected to a PLC 130, such as an Allen-Bradley Control Logix PLC. Through the interface of the upper-end system and the PLC, the dispensing of pre-printed labels by the label dispenser can be controlled.

When a vehicle enters a station where the labels are suppose to be attached to a vehicle, the upper-end system determines if the vehicle is configured for that specific label.

A signal is then sent from the upper-end system to that label dispenser through the PLC. The Label Dispenser feeds a single label that the operator should attach to the vehicle. When the next vehicle arrives at the same station, another Label is released from the Label Dispenser. If the operator then notices two labels located at the dispenser, they realize they have missed attaching the label to a vehicle.

In an alternate embodiment, the label dispenser includes a sensor to indicate if the dispensed label has been taken by the operator. If not, the label dispenser can issue a warning signal to the operator before the vehicle moves to the next station, or the label dispenser can signal to the upper-end system through the PLC that the label has not been taken an applied. In this case, the upper-end system can signal the operator, or hold the vehicle at that station until the label is taken from the dispenser.

Any of these embodiments gives the operator an opportunity to attach the “missed” label to the vehicle that has entered into the next Station.

FIG. 2 depicts a flowchart of a simplified process in accordance with a preferred embodiment. Here, the product or vehicle being assembled first enters the assembly station (step 205), and the upper-end system determines the product options (step 210).

Next, the upper-end system determines, from the product options, if a label is required at this station (step 215). If not, this process ends (step 250).

If a label is required, the upper-end system signal to the PLC, which will in turn signal the label dispenser to dispense a label (step 220).

Optionally, the label dispenser will also detect whether the dispensed label has been taken (step 225). If so, then the process ends (step 250), or can return to step 215 to determine if another label is required.

If the label was not taken, before the product moves to the next station, the label dispenser can signal the operator that a label should be applied (step 230), and then return to step 225.

Alternate embodiments include any device that dispenses labels remotely from a PLC or similar device, based on a signal that is sent by an upper-end system. The dispensing of the labels could also be controlled solely by the PLC that also contains any specific build data for the manufactured item, so that the integration with the upper-end system is unnecessary. Based on the options for the manufactured item, the PLC would dispense the label automatically.

Alternately, the label dispenser can be attached to a photo-eye that is triggered automatically when vehicle (or other object being assembled) breaks a certain light curtain. This can then be positioned to be specific for the size of the vehicles being built (i.e. 2-door vs. 4-door vehicle). The design then does not require an upper-end system to send the trigger to the dispenser, but instead a photo-eye would control the dispensing of the label.

Alternately, a radio-frequency identification (RFID) tag or other machine-readable tag can be attached to the object being manufactured, that sufficiently identifies the object so that the label dispenser or PLC can determine what labels should be applied at that station. Upon identifying the object and determining the labels to be applied, the appropriate labels are dispensed.

Those skilled in the art will recognize that, for simplicity and clarity, the full structure and operation of all systems suitable for use with the present invention is not being depicted or described herein. Instead, only so much of a system as is unique to the present invention or necessary for an understanding of the present invention is depicted and described. The remainder of the construction and operation of the disclosed embodiments may conform to any of the various current implementations and practices known in the art.

Although an exemplary embodiment of the present invention has been described in detail, those skilled in the art will understand that various changes, substitutions, variations, and improvements of the invention disclosed herein may be made without departing from the spirit and scope of the invention in its broadest form.

None of the description in the present application should be read as implying that any particular element, step, or function is an essential element which must be included in the claim scope: the scope of patented subject matter is defined only by the allowed claims. Moreover, none of these claims are intended to invoke paragraph six of 35 USC §112 unless the exact words “means for” are followed by a participle.

What is claimed is:

1. A method for product assembly, comprising:
determining product options for a product at an assembly station;
determining, from the product options, if a product label is required for the product at the assembly station; and
selectively dispensing a product label, at the assembly station, according to the product options.

2. The method of claim 1, further comprising
detecting whether the dispensed label has been removed from a label dispenser; and
signaling an operator if the dispensed label has not been removed from the label dispenser.

3. The method of claim 1, further comprising keeping the product at the assembly station until any dispensed product label is removed from a label dispenser.

4. The method of claim 1, wherein the product is a vehicle.

5. The method of claim 1, wherein an upper-end system determines the product options.

6. The method of claim 1, wherein the product has a radio-frequency identification tag.

7. The method of claim 1, wherein the label is dispensed by a label dispenser controlled by a PLC.

8. A product assembly system, comprising:
a controller for determining product options for a product at an assembly station and determining, from the product options, if a product label is required for the product at the assembly station; and
a label dispenser, controlled by the controller, for selectively dispensing a product label, at the assembly station, according to the product options.

9. The product assembly system of claim 8, wherein the label dispenser is configured to detect whether the dispensed label has been removed from a label dispenser and to signal an operator if the dispensed label has not been removed from the label dispenser.

10. The product assembly system of claim 8, wherein the controller keeps the product at the assembly station until any dispensed product label is removed from the label dispenser.

11. The product assembly system of claim 8, wherein the product is a vehicle.

12. The product assembly system of claim 8, wherein the controller includes an upper-end system.

13. The product assembly system of claim 8, wherein the product has a radio-frequency identification tag.

14. The product assembly system of claim 8, wherein the controller includes a PLC.
